(19) United States
(12) Patent Application Publication
(10) Pub. No.: US 2026/0017104 A1
(43) Pub. Date: Jan. 15, 2026

(54) LOGISTICS CONTROL SYSTEM

(71) Applicant: TOYOTA JIDOSHA KABUSHIKI KAISHA, Toyota-shi (JP)

(72) Inventors: Junta NISHITANI, Toyota-shi (JP); Daigo ISHIKAWA, Toyota-shi (JP); Shu NISHIBE, Toyota-shi (JP)

(73) Assignee: TOYOTA JIDOSHA KABUSHIKI KAISHA, Toyota-shi (JP)

(21) Appl. No.: 19/260,763

(22) Filed: Jul. 7, 2025

(30) Foreign Application Priority Data
Jul. 11, 2024 (JP) 2024-111591

(51) Int. Cl. G06F 9/50

(52) U.S. Cl. CPC G06F 9/5027

(57) ABSTRACT

A logistics control system includes: a task control unit that creates a task sequence including a transfer task of an object-being-transferred by a movable body, and controls the transfer task in accordance with the task sequence; and an operation command transmission unit that, upon receiving a start instruction for the transfer task from the task control unit, transmits an operation command for the movable body to the movable body. The task sequence is in a form of a list in which one or more tasks are arrayed in order of execution. The task control unit modifies the task sequence so as to add, change, or delete one or more tasks according to a change in a layout or equipment in a logistics facility.

### CROSS-REFERENCE TO RELATED APPLICATION

This application claims priority to Japanese Patent Application No. 2024-filed on Jul. 11, 2024. The disclosure of the above-identified application, including the specification, drawings, and claims, is incorporated by reference herein in its entirety.

### BACKGROUND

### 1. Technical Field

The present disclosure relates to a logistics control system.

### 2. Description of Related Art

Japanese Unexamined Patent Application Publication No. 2024-17484 (JP 2024-17484 A) discloses a movable body traffic management system that efficiently arbitrates traffic of a movable body that moves autonomously. This movable body traffic management system includes a storage unit that stores resources required for traffic of the movable body as resource data, a resources management unit that manages a status of allocation of the resources to the movable body, and a usage request processing unit that accepts a request from the movable body and newly allocates the resources, and frees the resources when usage by the movable body has ended.

### SUMMARY

One problem with the above-described related art is that changing the system in response to a change in a layout or equipment is complicated, which makes it difficult to change the layout or the equipment from the viewpoints of costs and lead time. Thus, a system technology that can easily respond to a change in a layout or equipment is desired.

(1) According to a first aspect of the present disclosure, a logistics control system is provided that performs control of a logistics facility in which one or more robots including a movable body are used. This logistics control system includes: a task control unit that creates a task sequence including a transfer task of an object-being-transferred by the movable body, and controls the transfer task in accordance with the task sequence; and an operation command transmission unit that, upon receiving a start instruction for the transfer task from the task control unit, transmits an operation command for the movable body to the movable body. The task sequence is in a form of a list in which one or more tasks are arrayed in order of execution, and the task control unit modifies the task sequence so as to add, change, or delete one or more tasks according to a change in a layout or equipment in the logistics facility.

This logistics control system can easily respond to a change in the layout or the equipment by modifying the task sequence.

(2) In the above-described logistics control system, the task sequence may be configured to include an interlock task of showing an on or off state of interlock relating to a transfer state of the object-being-transferred.

This logistics control system can appropriately execute transfer of the object-being-transferred by the movable body in accordance with the task sequence including the interlock task.

(3) In the above-described logistics control system, the transfer task may be configured to include a robot ID of the movable body and a transfer destination ID of the object-being-transferred, and not include a control parameter for controlling operation of the movable body.

This logistics control system can control the transfer of the object-being-transferred by the movable body by using the task sequence of a simple configuration.

(4) In the above-described logistics control system, each task included in the task sequence may include a plurality of items common to the tasks; the items may include a plurality of transfer task items and a plurality of interlock task items; for the transfer task, valid data may be registered for the transfer task items; and for the interlock task, valid data may be registered for the interlock task items.

This logistics control system can register each of the transfer task and the interlock task using the same items.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram showing a configuration of a logistics facility in an embodiment;

FIG. 2 is an explanatory view showing one example of a transfer path of an object-being-transferred by a movable body and a task sequence;

FIG. 3 is an explanatory view showing one example of a task sequence that has been modified according to a change in the logistics facility; and

FIG. 4 is an explanatory view showing another example of a task sequence that has been modified according to a change in the logistics facility.

### DETAILED DESCRIPTION OF EMBODIMENTS

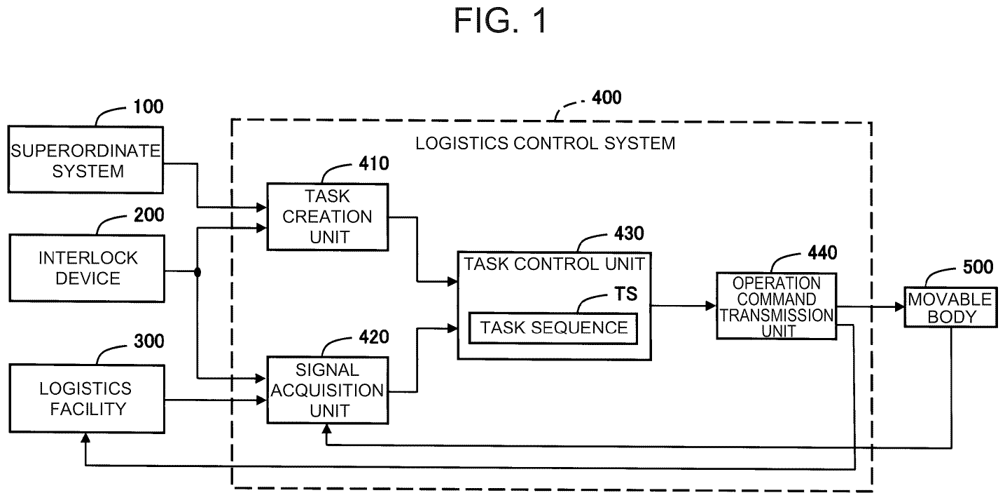

FIG. 1 is a block diagram showing a configuration of a logistics facility in an embodiment. This logistics facility includes a superordinate system 100, an interlock device 200, logistics equipment 300, a logistics control system 400, and a movable body 500. This logistics facility is configured to use one or more robots including the movable body 500. The logistics facility is, for example, a factory. The logistics control system 400 is connected to other devices and equipment in the logistics facility by wire or wirelessly.

The superordinate system 100 is a system that manages actual performance of a production process and a logistics process in the logistics facility. Current positions of individual loads and a current position of the movable body 500 are also managed by the superordinate system 100. In the present disclosure, “load” and “object-being-transferred” are synonyms. The superordinate system 100 further has a function of notifying the logistics control system 400 of tasks to be executed in various logistics processes.

The interlock device 200 has a function of switching between on and off states of interlock in a logistics process and making a notification to the logistics control system 400. The interlock device 200 can be composed of various sensors installed in a logistics process, such as a laser scanner or a light curtain, and various buttons, such as a work completion button. The interlock relating to a transfer state of an object-being-transferred is information showing whether the transfer state of the object-being-transferred meets a specific condition or procedure. The on state of the interlock means that, as the specific condition or procedure is not met, operation relating to the object-being-transferred should be stopped. The off state of the interlock means that, as the specific condition or procedure is met, operation relating to the object-being-transferred can be executed. The on and off states of typical interlock are determined according to at least one of the transfer state of the object-being-transferred by the movable body 500 and another state in the logistics facility.

The logistics equipment 300 is equipment introduced in a logistics process. As the logistics equipment, for example, robots, such as an automated storage-retrieval system (ASRS), can be used. The ASRS operates as a main executer of a storage task of storing an object-being-transferred. The logistics equipment 300 has a function of notifying various signals relating to its operation to the logistics control system 400.

The logistics control system 400 includes a task creation unit 410, a signal acquisition unit 420, a task control unit 430, and an operation command transmission unit 440.

The task creation unit 410 creates various tasks, such as a transfer task of an object-being-transferred and an interlock task, according to a notification from the superordinate system 100 or the interlock device 200, and notifies the task control unit 430 of the created tasks.

The signal acquisition unit 420 acquires various signals from the interlock device 200, the logistics equipment 300, and the movable body 500, and notifies the task control unit 430 of the acquired signals.

The task control unit 430 creates a task sequence TS including one or more tasks, such as a transfer task and an interlock task, according to information supplied from the task creation unit 410 and the signal acquisition unit 420. Examples of the task sequence TS will be described later. The task control unit 430 has a function of controlling various tasks using the movable body 500 and the logistics equipment 300 in accordance with the task sequence TS.

Upon receiving a start instruction for a transfer task from the task control unit 430, the operation command transmission unit 440 transmits an operation command to the movable body 500. The operation of the movable body 500 includes, for example, traveling, rotating, and elevating and lowering a lift. The operation command transmission unit 440 breaks down the operation of the movable body 500 required to execute a transfer task into fine operations adapted to the configuration of the movable body 500, and creates an operation command relating to the broken-down operations. The operation command transmission unit 440 may further have a function of transmitting an operation command to the logistics equipment 300 upon receiving a start instruction from the task control unit 430 relating to a task a main executer of which is the logistics equipment 300.

The functions of the respective units of the logistics control system 400 are realized as a processor executes computer programs stored in a memory. Or some or all of the functions of the respective units of the logistics control system 400 may be realized by a hardware circuit.

The movable body 500 is a robot serving as a main executer that executes a transfer task of an object-being-transferred. As the movable body 500, for example, an automated guided vehicle (AGV), an autonomous mobile robot (AMR), or an automated guided forklift (AGF) can be used. The movable body 500 operates in accordance with the operation command received from the operation command transmission unit 440.

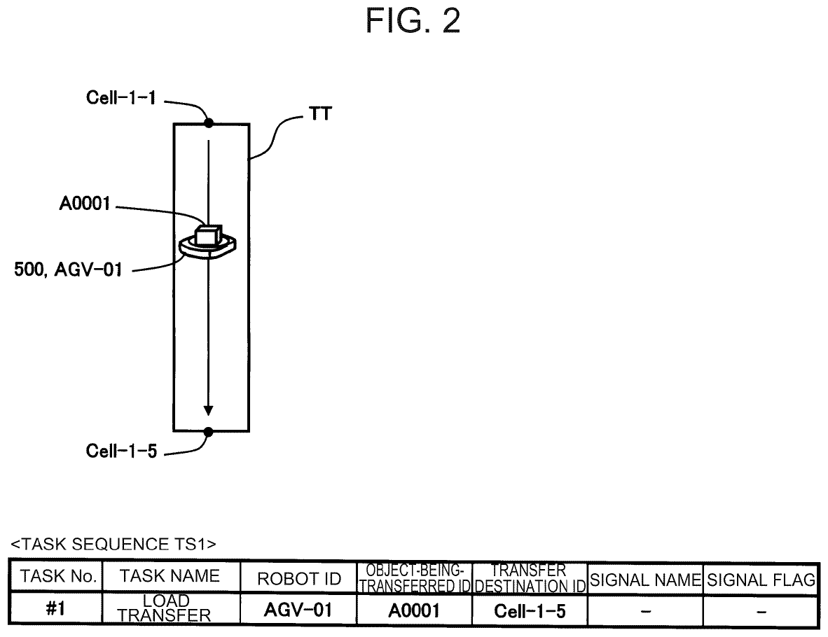

FIG. 2 is an explanatory view showing one example of a transfer path of an object-being-transferred by the movable body 500 and the task sequence TS. At the top of FIG. 2, a transfer track TT set in the logistics facility and the movable body 500 traveling on the transfer track TT are depicted. The transfer track TT is a path for transferring an object-being-transferred A0001 from a start point Cell-1-1 to an end point Cell-1-5.

The task sequence TS1 shown at the bottom of FIG. 2 is configured to include a transfer task on the transfer track TT. Each task registered for the task sequence TS1 includes the following items:

### <Task No.>

Shows the order of a task executed in the task sequence.

### <Task Name>

The name of a task. In the example of FIG. 2, the task name is “load transfer,” showing that the task is a transfer task.

### <Robot ID>

An ID of a robot that executes a task.

### <Object-Being-Transferred ID>

An ID of an object-being-transferred that is handled in a task.

### <Transfer Destination ID>

An ID of an end point in a transfer task.

### <Signal Name>

The signal name of an interlock signal used in an interlock task.

### <Signal Flag>

A flag indicating a signal level of an interlock signal for completing an interlock task.

Some of the above-described items composing each task may be omitted. For example, the object-being-transferred ID may be omitted. Each task may be configured to include items other than those described above. For example, each task may be configured to include a transfer origin ID of a transfer task. In this embodiment, however, since the superordinate system 100 manages the current position of an object-being-transferred, it is not necessary to register information showing the transfer origin for the task sequence TS.

In the example of FIG. 2, only one transfer task #1 is registered for the task sequence TS1. For the transfer task #1, valid data is registered for the items other than the signal name and the signal flag. Invalid data is registered for the signal name and the signal flag.

As can be understood from the example of FIG. 2, the transfer task is configured to include the robot ID and the transfer destination ID of the movable body 500 and not include a control parameter for controlling the operation of the movable body 500. Thus, the task control unit 430 can control the transfer of an object-being-transferred by the movable body 500 by using the task sequence TS of a simple configuration.

The task sequence TS1 is started upon a start request that is notified from an external device to the logistics control system 400. The external device is the superordinate system 100, a work start button, etc. Upon this start request, the task creation unit 410 creates a task sequence. Thereafter, a start instruction for the transfer task #1 is notified from the task control unit 430 to the operation command transmission unit 440, and an operation command for executing the transfer task #1 is transmitted from the operation command transmission unit 440 to the movable body 500. Thereafter, when the movable body 500 arrives at the transfer destination, an arrival signal is transmitted from the movable body 500 to the signal acquisition unit 420, and a notification is made to the task control unit 430. Upon receiving this notification, the task control unit 430 can determine that the transfer task #1 has been completed.

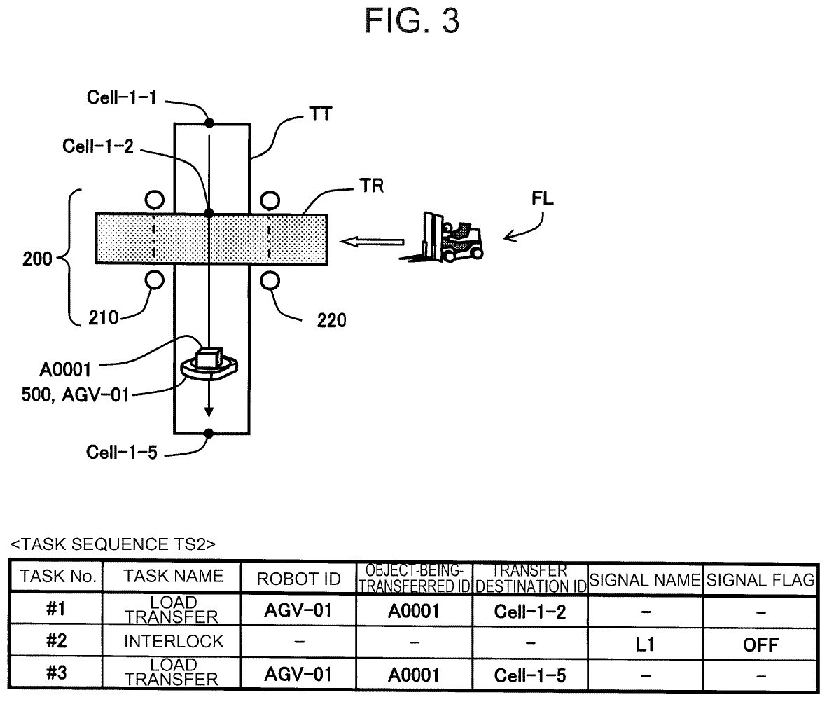

FIG. 3 is an explanatory view showing one example of the task sequence TS that has been modified in response to a change in the logistics facility. At the top of FIG. 3, a state is depicted where a traverse route TR traversing the transfer track TT is set at an intermediate point of the transfer track TT shown in FIG. 2. This traverse route TR is for passage of an object, such as a forklift FL. At an intersection of the transfer track TT and the traverse route TR, an intermediate transfer destination Cell-1-2 is set.

At an intersecting portion of the transfer track TT and the traverse route TR, two laser scanners 210, 220 constituting the interlock device 200 are provided. The interlock device 200 sets the interlock signal to ON in a state where an object, such as the forklift FL, has entered the intersecting portion of the transfer track TT and the traverse route TR, and sets the interlock signal to OFF in a state where an object has not entered the intersecting portion of the transfer track TT and the traverse route TR.

An automated guided vehicle AMR-01 as the movable body 500 first transfers the object-being-transferred A0001 to the intermediate transfer destination Cell-1-2. At this point, if the interlock signal of the interlock device 200 is OFF, the movable body 500 continues the transfer to the final transfer destination Cell-1-5. On the other hand, if the interlock signal is ON when reaching the intermediate transfer destination Cell-1-2, the movable body 500 temporarily stands by there, and after the object, such as the forklift FL, has passed and the interlock signal has turned off, resumes the transfer from the intermediate transfer destination Cell-1-2 to the final transfer destination Cell-1-5.

For the task sequence TS2 shown at the bottom of FIG. 3, the above-described transfer process is registered as three tasks #1 to #3. The first task #1 is a transfer task of transferring the object-being-transferred A0001 to the intermediate transfer destination Cell-1-2. This transfer task #1 is equivalent to the task #1 shown in FIG. 2 with its transfer destination ID changed. The transfer task #1 of FIG. 3 is completed when the movable body 500 reaches the intermediate transfer destination Cell-1-2.

The second task #2 is an interlock task of standing by until an interlock signal L1 of the interlock device 200 turns off. For the interlock task #2, valid data is registered for the signal name and the signal flag. Invalid data is registered for the items other than the signal name and the signal flag. The interlock task #2 is started after completion of the first transfer task and completed when the interlock signal L1 turns off.

The third task #3 is a transfer task of transferring the object-being-transferred A0001 from the intermediate transfer destination Cell-1-2 to the final transfer destination Cell-1-5. This transfer task #3 is started after completion of the immediately preceding interlock task #2.

The task sequence TS2 shown in FIG. 3 includes a plurality of tasks and is configured such that, after completion of each task, the next task is started. The task sequence TS2 is a list in which a plurality of types of tasks including a transfer task and an interlock task is arrayed in order of execution using a single form of task composed of a plurality of items common to the tasks.

Of the items common to the tasks, the robot ID, the object-being-transferred ID, and the transfer destination ID are transfer task items that are registered for transfer tasks. The signal name and the signal flag are interlock task items that are registered for interlock tasks. The task No. and the task name are common items that are commonly used by all tasks. For a transfer task, valid data is registered for the transfer task items while invalid data is registered for the interlock task items. On the other hand, for an interlock task, valid data is registered for the interlock task items while invalid data is registered for the transfer task items. Thus, the task sequence TS is configured such that each of a transfer task and an interlock task can be registered by using a plurality of items common to the tasks.

The task control unit 430 can manage, at the same hierarchical level, a plurality of types of tasks including a transfer task and an interlock task by using the task sequence TS. “The same hierarchical level” means that a plurality of tasks is not configured so as to overlap and is registered in a form of a list in which these tasks are arrayed in order of execution. “Overlapped” means such a configuration that another task is executed in the middle of one task. It is preferable that, for the task sequence TS, tasks other than a transfer task and an interlock task, such as a storage task of storing a load in a warehouse or a storage rack and a retrieval task of retrieving a load from a warehouse or a storage rack can be registered. Tasks other than interlock that are registered for the task sequence TS can also be called “logistics tasks.” For a storage task and a retrieval task, too, valid data is registered for the same items as for a transfer task.

As can be understood from the example of FIG. 3, the task control unit 430 can modify the task sequence TS so as to add or change one or more tasks according to a change in the layout in the logistics facility. By thus modifying the task sequence TS, a change in the layout can be easily responded to.

Creation and modification of the task sequence TS may be executed by the task control unit 430 according to a user's instructions, or may be automatically executed by the task control unit 430. What is common to both cases is that the task control unit 430 creates and modifies the task sequence TS.

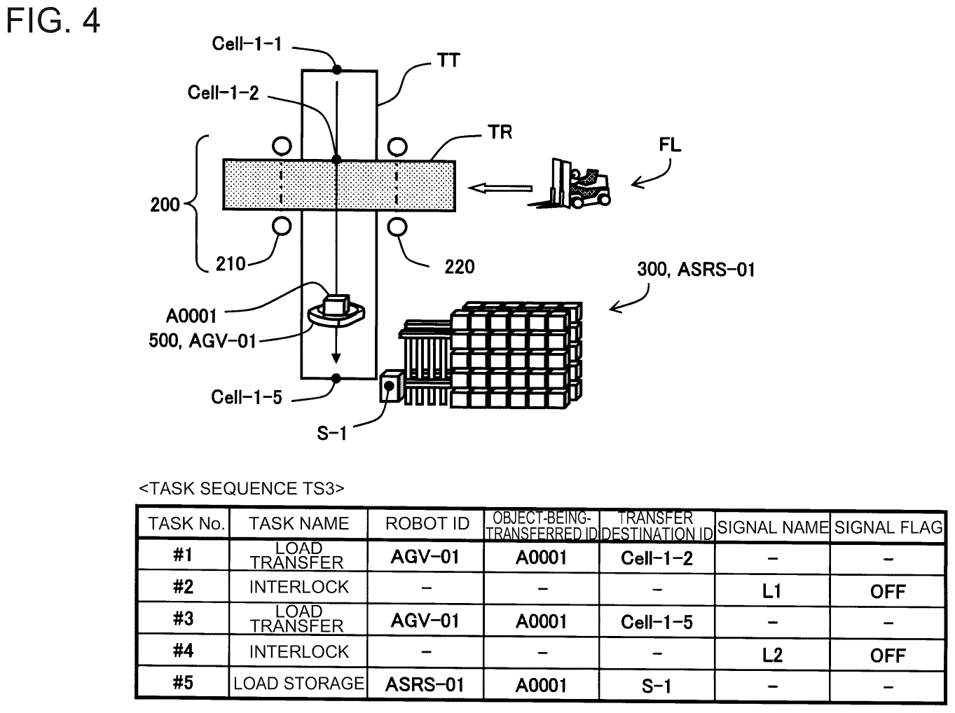

FIG. 4 is an explanatory view showing another example of the task sequence TS that has been modified in response to a change in the logistics facility. At the top of FIG. 4, a state is depicted where an automated storage-retrieval system ASRS-01 as the logistics equipment 300 is added at a final transfer destination Cell-2-5 of the transfer track TT. A position S-1 of a storage-retrieval station of the automated storage-retrieval system ASRS-01 is used as the transfer destination of a storage task of the object-being-transferred A0001 by the automated storage-retrieval system ASRS-01.

The task sequence TS3 shown at the bottom of FIG. 4 is the task sequence TS2 shown in FIG. 3 with a fourth interlock task #4 and a fifth storage task #5 added thereto. The interlock task #4 is a task of showing whether a handover condition for handing over the object-being-transferred A0001 having been transferred to the transfer destination Cell-1-5 by the automated guided vehicle AMR-01 to the automated storage-retrieval system ASRS-01 is met. When the handover condition is met, an interlock signal L2 turns off. The interlock device that issues the interlock signal L2 is not shown. When the interlock signal L2 turns off, the interlock task #4 is completed and the storage task #5 is started. That is, the object-being-transferred A0001 is housed in the automated storage-retrieval system ASRS-01.

As can be understood from the example of FIG. 4, the task control unit 430 can modify the task sequence TS so as to add or change one or more tasks according to a change in the equipment in the logistics facility. By thus modifying the task sequence TS, a change in the equipment can be easily responded to.

When the automated storage-retrieval system ASRS-01 is omitted from the state of FIG. 4, the two tasks #4 and #5 are deleted from the task sequence TS3, which results in the state of FIG. 3. When the traverse route TR is deleted from the state of FIG. 3, the two tasks #2 and #3 are deleted from the task sequence TS2 and the task #1 is modified, which results in the state of FIG. 2. Thus, in some cases, one or more tasks are deleted or modified according to a change in the layout or the equipment.

As can be understood from the examples of FIGS. 2 to 4, the task sequence TS is in the form of the list in which one or more tasks are arrayed in order of execution. It is preferable that one task sequence TS be a list of one or more tasks relating to the same object-being-transferred.

As has been described above, in this embodiment, the task control unit 430 modifies the task sequence TS so as to add, change, or delete one or more tasks according to a change in the layout or the equipment in the logistics facility. By thus modifying the task sequence TS, a change in the layout or the equipment can be easily responded to.

### Other Aspects

The present disclosure is not limited to the above-described embodiment, and can be realized in various aspects within such a range that no departure is made from the gist of the disclosure. For example, the present disclosure can also be realized in the following aspects. The technical features in the above-described embodiment that correspond to technical features in the aspects to be described below can be substituted or combined as appropriate to solve some or all of the problem of the present disclosure or achieve some or all of the effects of the present disclosure. Unless a technical feature is described as essential in the present specification, it can be omitted as appropriate.

The present disclosure can also be realized in various aspects other than a logistics control system. For example, the present disclosure can be realized in aspects of a method of performing control of a logistics facility, a computer program that executes the processes of the logistics control system, and a non-transitory storage medium that stores the computer program.

What is claimed is:

1. A logistics control system that performs control of a logistics facility in which one or more robots including a movable body are used, the logistics control system comprising:
a task control unit that creates a task sequence including a transfer task of an object-being-transferred by the movable body, and controls the transfer task in accordance with the task sequence; and
an operation command transmission unit that, upon receiving a start instruction for the transfer task from the task control unit, transmits an operation command for the movable body to the movable body, wherein:
the task sequence is in a form of a list in which one or more tasks are arrayed in order of execution; and
the task control unit modifies the task sequence so as to add, change, or delete one or more tasks according to a change in a layout or equipment in the logistics facility.

2. The logistics control system according to claim 1, wherein the task sequence is configured to include an interlock task of showing an on or off state of interlock relating to a transfer state of the object-being-transferred.

3. The logistics control system according to claim 1, wherein the transfer task is configured to include a robot ID of the movable body and a transfer destination ID of the object-being-transferred, and not include a control parameter for controlling operation of the movable body.

4. The logistics control system according to claim 2, wherein:
each task included in the task sequence includes a plurality of items common to the tasks;
the items include a plurality of transfer task items and a plurality of interlock task items;
for the transfer task, valid data is registered for the transfer task items; and
for the interlock task, valid data is registered for the interlock task items.
